(19) United States
(12) Patent Application Publication
(10) Pub. No.: US 2016/0250700 A1
(43) Pub. Date: Sep. 1, 2016

(54) DEBURRING TOOL FOR DEBURRING OF NONROUND CONTOURS OF WORKPIECES

(71) Applicant: Heule Werkzeug AG, Balgach (CH)

(72) Inventor: Harry Studer, Balgach (CH)

(21) Appl. No.: 15/054,584

(22) Filed: Feb. 26, 2016

(30) Foreign Application Priority Data
Feb. 27, 2015 (DE) 10 2015 002 503.1

(51) Int. Cl. B23D 79/02

(52) U.S. Cl. CPC B23D 79/023

(57) ABSTRACT

Deburring tool for deburring of nonround contours on workpieces (22) consisting of a tool shaft (1) for fastening in a path guiding machine (32), which is suitable to guiding the deburring tool (1, 2) by its machine movement (29, 30, 33) along a workpiece contour (24) which is nonround in at least the radial direction, wherein at least one deburring blade (12) having at least one cutting edge (14) is pressed under spring loading against the workpiece contour (24) in chip removing manner and can be moved along the workpiece contour (24).

The invention concerns a deburring tool for the deburring of nonround contours on workpieces according to the preamble of patent claim 1.

With the subject matter of EP 0 446 767 B1 a deburring tool of the kind mentioned above has become known. This works with a spring-loaded tilting blade. The deburring tool is driven in rotation on the tool shaft and has rotary speeds in the range of 500 to 10000 revolutions per minute.

The deburring action thus occurs through a rotary movement of the deburring blade about the axial axis of a cylindrical borehole, while only the edges of the cylindrical borehole that are directed forward and backward in the axial direction are to be deburred. Such a deburring tool is not suitable for the deburring of nonround borehole diameters in the radial direction of a borehole or a nonround recess.

The same drawback also applies to EP 2 161 090 A2, although this proposes a deburring blade for the deburring of regular and irregular borehole edges. However, by the term “irregular borehole edges” is meant only that the contour changes in the axial direction, but not the radial direction.

Therefore, the problem which the invention proposes to solve is to create a deburring tool for the deburring of radially nonround and optionally also axially nonround contours on workpieces.

For the solution of the stated problem, the invention is characterized by the technical teaching of claim 1.

One feature of the invention is that now the deburring tool is configured as a path following tool, which means that it is not driven in axial rotation in regard to its center longitudinal axis, but instead it is moved along the nonround workpiece contour in the manner of peeling tool or skiving tool, so that the deburring tool is dependent on a path guiding machine, which dictates the workpiece contour to be deburred and guides the deburring tool along this workpiece contour.

This path guiding machine is a machine control system which is able to turn the deburring tool of the invention toward the nonround workpiece contours looking in the radial direction.

The tracking of a deburring tool in the manner of a path following tool means that the workpiece contour being tracked is reproduced approximately in a path guiding machine which guides the deburring tool and moves it precisely along this simulated guidance contour.

Therefore, this is not a deburring blade which is driven in rotation, but rather a deburring blade whose longitudinal axis essentially stands always perpendicular, to the path contour, so that the best deburring or peeling effect is achieved. However, the invention is not confined to a precisely perpendicular orientation of the longitudinal axis of the deburring blade to the longitudinal axis of the particular path. Angles between the longitudinal axis of the deburring blade and the path contour can also be specified in the range of 0 to 15 degrees.

Insofar as there is an angle between the longitudinal axis of the deburring blade and the longitudinal axis of the workpiece contour being tracked, this involves a slanting deburring blade which follows the intended guidance path in the manner of a peeling blade or a skiving blade at a certain angle position. Therefore, in many cases the peeling or skiving effect can be improved in the chip-removing machining of borehole edges.

The invention is also characterized in that it concerns a path following tool configured as a deburring tool, and the chip-removing tool is designed as a deburring blade, which moves through a chip removal process along a workpiece contour which is nonround—possibly also in the horizontal direction—but also nonround in the radial direction and often curved.

Thus, the invention is not suited to a deburring tool for path following of workpiece contours that are nonround in the radial direction, but it can also be provided in addition that the workpiece contour is nonround in the horizontal plane, that is, the workpiece contour which is nonround in the radial direction is additionally provided with peaks and valleys in the axial direction, and the spring-loaded deburring blade according to the invention is able to follow these peaks and valleys in conjunction with the additionally radially nonround workpiece contour for reliable deburring of the workpiece contours in two mutually perpendicular directions.

The use of a deburring tool according to the invention plays a special role in the deburring of cast iron workpieces and especially the deburring of turbocharger housings or compressor housings, for example.

Namely, such cast iron housings have the problem that nonround, especially spiral cast iron contours are present, which need to be deburred for a cast iron housing of a turbocharger in order to form high-quality inlet and flow surfaces.

This is where the invention comes into play, stipulating that the deburring tool is also suitable for the exterior deburring of nonround, especially spiral workpiece contours.

Interior deburring, that is, the deburring of interior workpiece contours, is relatively familiar and is also possible by the aforementioned deburring tools, although they are driven in rotation.

Instead, the present invention concerns a deburring tool which proposes an outwardly slanted, spring-loaded deburring blade, on whose one side, preferably the bottom side, at least one cutting edge is arranged. The cutting edge behaves like a peeling strip or a peeling edge and is placed under spring loading against the workpiece contour being deburred and moved along this radially variable workpiece contour. Furthermore, the radially variable workpiece contour can also be uneven in the axial direction and it is reliably deburred. There is no rotary driving of the tool shaft oriented in the axial direction.

Another feature of the invention is that in the resting state the spring-loaded, swivel-mounted deburring blade is oriented by a defined angle outwardly from the base body of the deburring blade, that is, in the unloaded resting state it stands with its cutting edge radially outward beyond the outer circumference of the base body.

Thus, for the first time it is possible to move into a borehole or a recess and deburr the radially outward lying workpiece contours facing away from the borehole or recess with such a deburring blade.

In the unloaded resting state the deburring blade forms an element angle between 30 and 60 degrees by its longitudinal axis with respect to the vertical, it being characteristic that the element angle is maintained spring-loaded in the resting state.

Once the deburring blade with the blade holder attached to it swivels out from its spring-loaded neutral position by an angle, for example by being placed spring-loaded against a workpiece contour being tracked, the aforementioned spring-biased peeling or skiving effect occurs.

For example, the deburring blade starting from an element angle (of 45 degrees for example) now adopts a working angle of 60 degrees. At this working angle, the deburring blade is spring-loaded under the action of a suitable bending spring or another suitable force accumulator and pressed against the workpiece contour and guided with spring loading along this workpiece contour.

In the sample embodiment depicted, the deburring blade is designed for the deburring of a contour facing away from a borehole. Accordingly, the radially outwardly lying contour of a stepped recess will be deburred.

In a reversal of the described deburring blade, however, it is also provided that the deburring blade is suitable for the deburring of workpiece contours that are situated on the inner side of the borehole, that is, on the interior.

Separate patent protection is claimed for both application cases.

Moreover, neither is the invention confined to the spring tensioning of the blade holder held rotatable and spring-loaded in a base body.

In one preferred embodiment, however, it is provided that the outer circumference of a somewhat round shaped blade holder rotatably held in a recess in the base body engages with the freely bendable end of a leaf spring, which thereby holds the deburring blade, firmly accommodated in the blade holder, in a defined outwardly swiveled resting position, while the spring force is strengthened only upon swiveling of the blade holder into a working position.

In another embodiment of the invention, instead of a leaf spring other spring loading elements or force accumulators can be used to tension the blade holder. Thus, a torsion spring can be arranged at the center of rotation of the blade holder, which holds the blade holder under spring loading in a defined basic position, and the spring force is strengthened when the blade holder is turned about a defined rotary position outside of its resting position.

In all sample embodiments it is presumed that the deburring blade is secured in the radial direction in a somewhat cylindrical blade holder, while the invention is not dependent on a solitary deburring blade. It can also be provided that instead of a solitary deburring blade there are now two opposing deburring blades arranged in the blade holder.

Instead of a torsion spring, which is preferably arranged at the center of rotation of the blade holder, other force accumulators can also be used, such as elastomer springs, helical compression springs, and the like.

Thus, it only matters that the blade holder is spring-tensioned with the radially outwardly slanting deburring blade in a defined outwardly slanting resting position, and the spring loading is strengthened once the deburring blade is swiveled from its outwardly swiveled resting position into an even more outwardly swiveled working position.

The subject matter of the present invention emerges not only from the subject matter of the individual patent claims, but also from the combination of the individual patent claims with each other.

All information and features disclosed in the documents, including the abstract, especially the spatial configuration depicted in the drawings, are claimed as essential to the invention, insofar as they are new in regard to the prior art, individually or in combination.

The invention shall be explained more closely below with the aid of drawings representing only one way of its implementation. Further essential features and benefits of the invention will emerge from the drawings and their description.

There are shown:

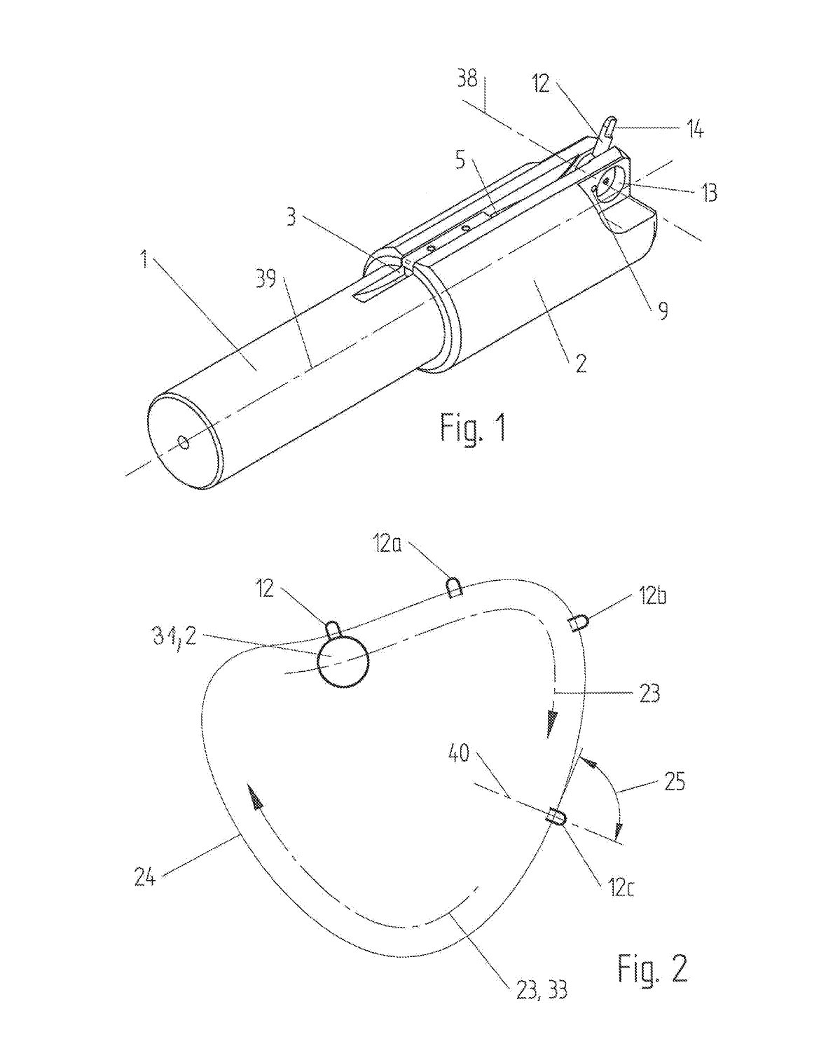

FIG. 1: perspective view of a deburring tool according to the invention

FIG. 2: schematized, a view of the path following of the deburring tool along a workpiece contour

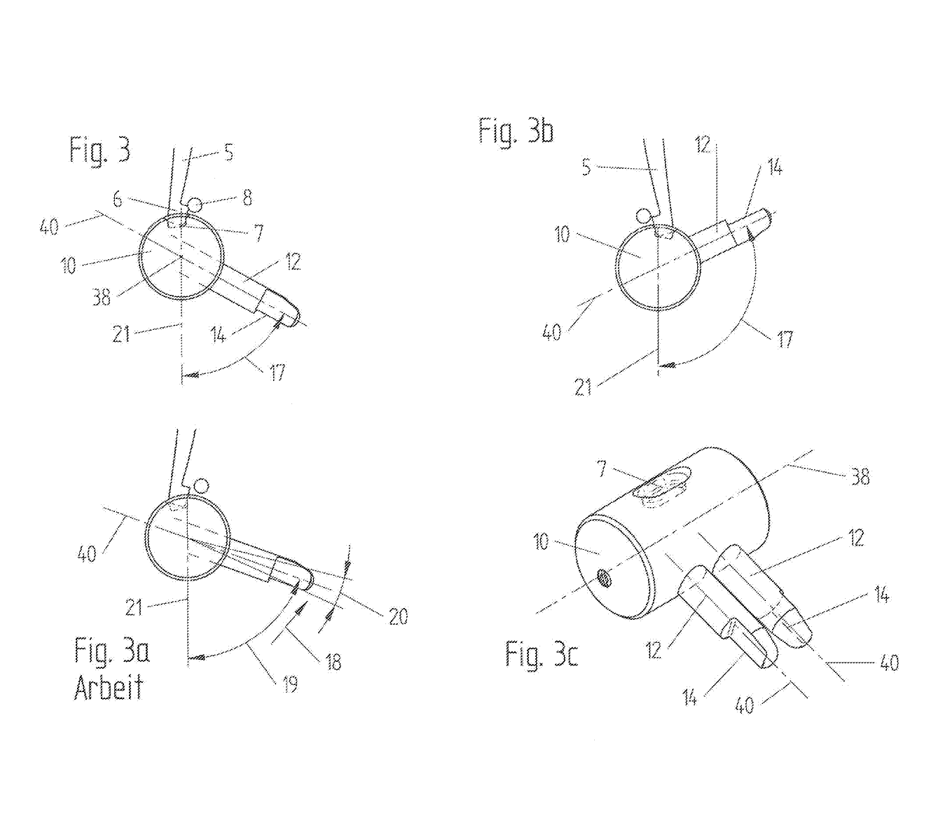

FIG. 3: schematized, the working principle of the deburring tool according to the invention in the resting position

FIG. 3a: schematized, the working principle in the working position

FIG. 3b: schematized, the reversal of the function of the deburring tool for the deburring of radially interior workpiece contours

FIG. 3c: a modified configuration with a double deburring blade

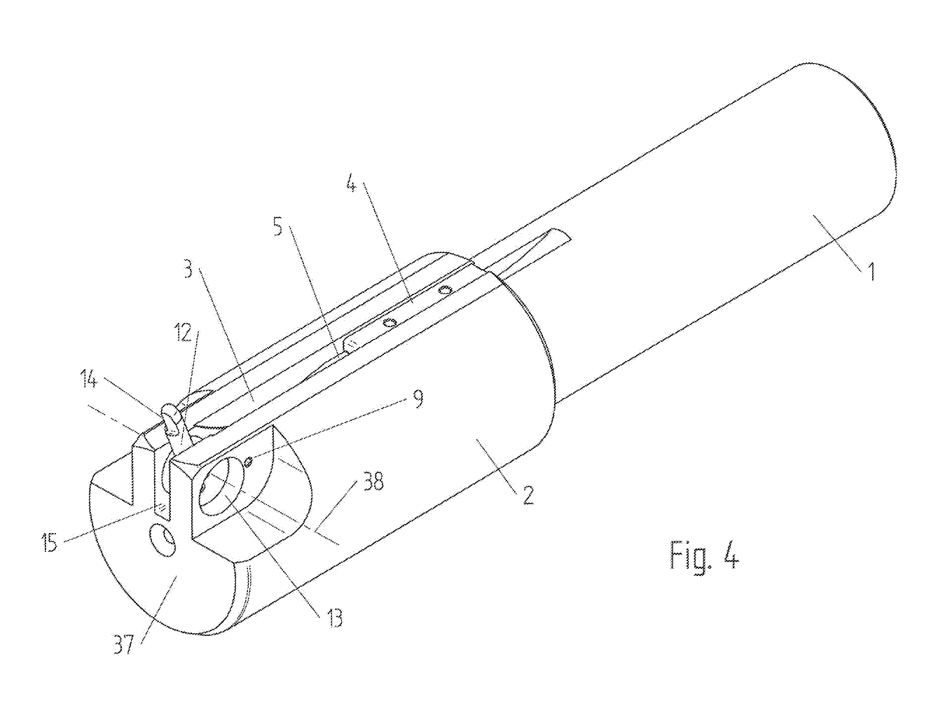

FIG. 4: a perspective view of the deburring tool in manner of the deburring tool of FIG. 1

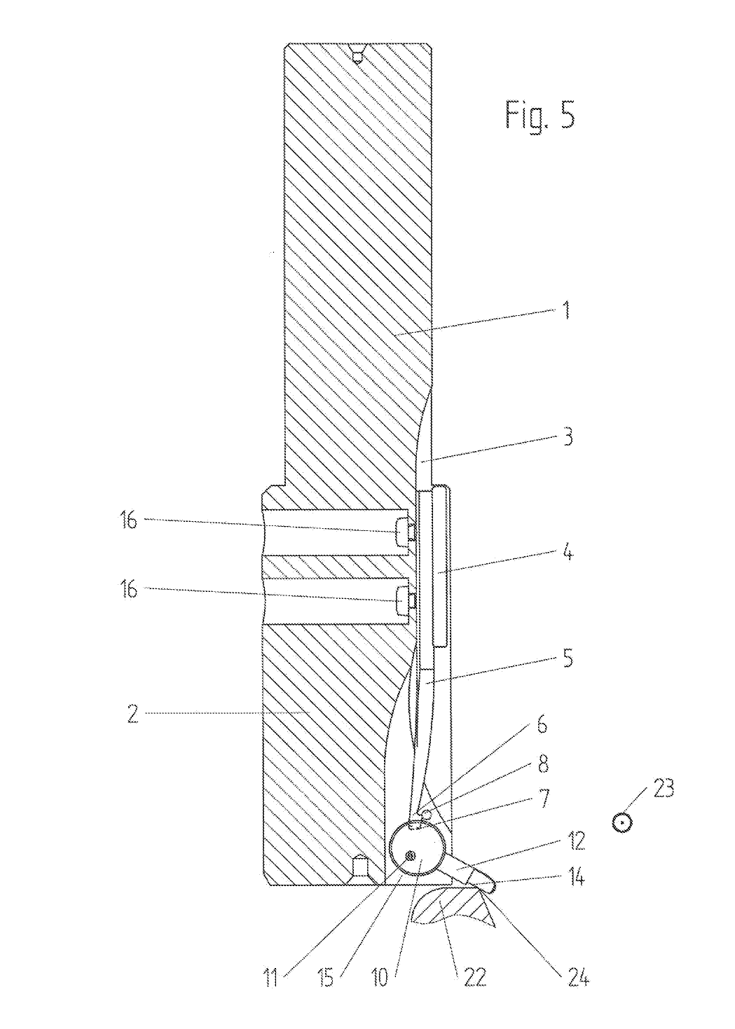

FIG. 5: section through a deburring tool during the deburring process

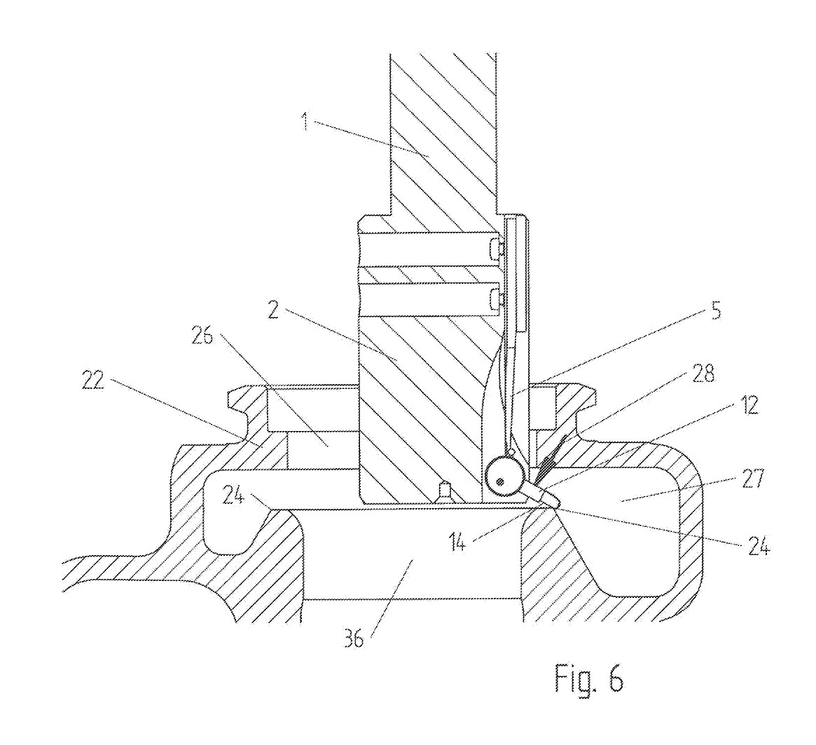

FIG. 6: the debarring tool of FIGS. 1 to 5 in the working position during the deburring of a radially exterior workpiece contour relative to a central workpiece opening

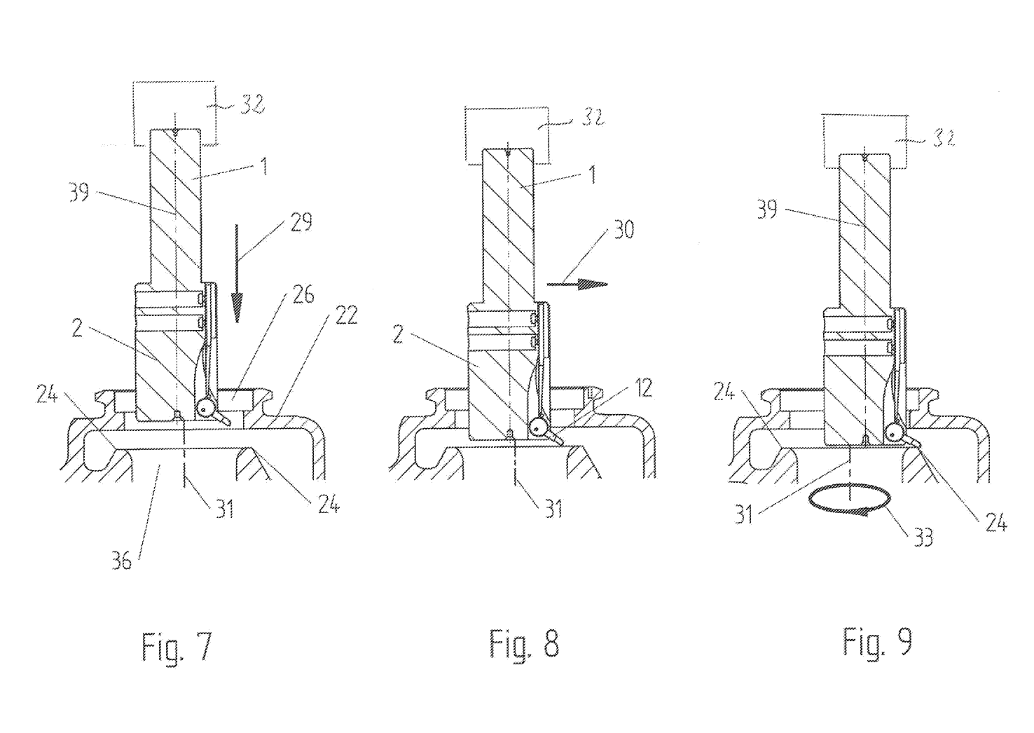

FIG. 7: a first process sequence introducing the debarring tool into a workpiece opening

FIG. 8: the continuing motion as compared to FIG. 7

FIG. 9: the final resting position of the deburring tool in the workpiece opening

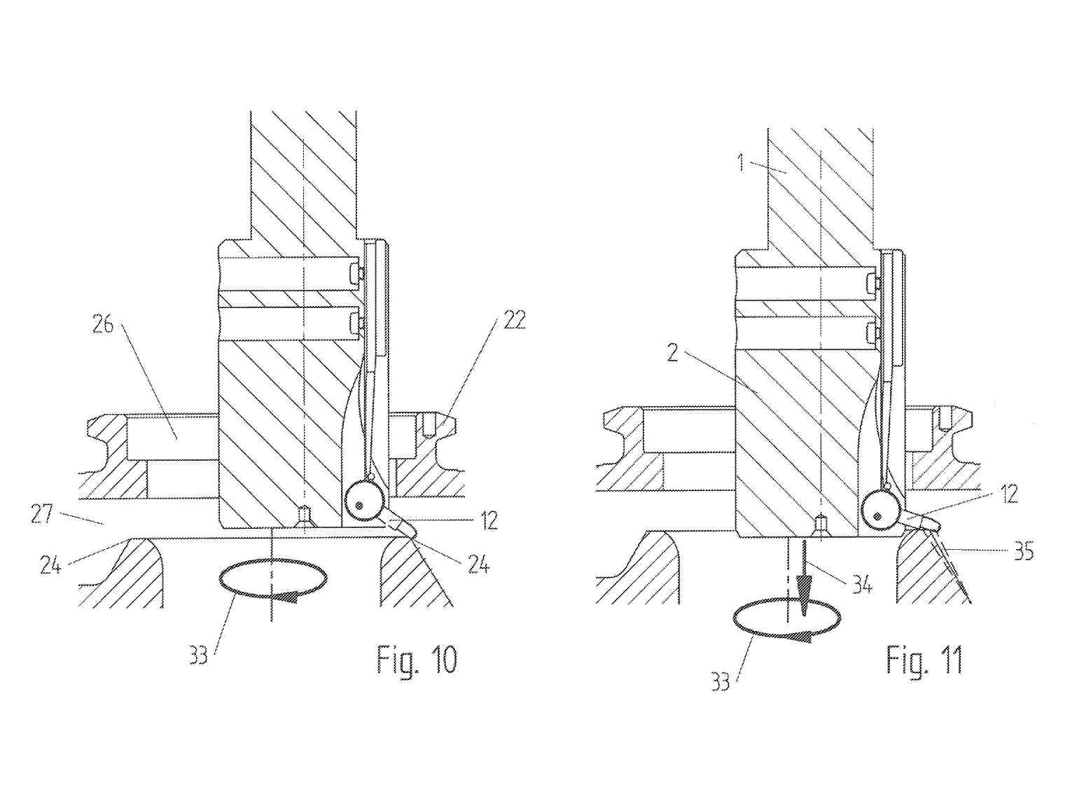

FIG. 10: the resting position of the deburring in a representation according to FIG. 9

FIG. 11: the working position of the deburring tool as compared to FIG. 10

The deburring tool according to the invention in FIG. 1 essentially consists of a cylindrical tool shaft 1, on which is secured an either single-piece or multiple-piece base body 2. In the base body 2 there is devised a lengthwise groove 3 machined at one side on the outer circumference of the base body 2, extending from the back part of the base body 2 to the front end face 37.

According to FIG. 5, in the region of the lengthwise groove 3 there is clamped a bending spring 5, whose rear end is held by a clamping strip 4. The clamping strip 4 is secured in the region of the base body 2 with the help of clamp screws 16, so that the rear end of the bending spring 5 is clamped at the rear part of the base body 2.

The front end of the bending spring 5 according to FIG. 5 engages in a radially machined hollowed-out recess 7 at the outer circumference of a blade holder 10 and is mounted there immovably.

The preferably cylindrically shaped blade holder 10 according to FIGS. 1 and 4 is rotatably mounted at the front free end of the base body 2 in bearing bores 13 which are arranged opposite and aligned with each other.

In FIGS. 1 and 4 the rotary axis 38 is shown. The rotary axis 38 is perpendicular to the longitudinal axis of the debarring tool.

The invention is not confined to the bearing bore 13 for the rotatable accommodation of the blade holder 10 being configured eccentrically to the center longitudinal axis of the base body 2.

In another embodiment it can also be provided that the bearing bore 13 is arranged centrally and aligned in the longitudinal axis 39 of the deburring tool.

What is important in the invention is that at least one deburring blade 12 is secured on the circumference of the blade holder 10, which is oriented outwardly, starting from the outer circumference of the blade holder 10.

The fastening of the debarring blade 12 in the blade holder 10 occurs preferably such that the longitudinal axis 40 passes through the deburring blade 12 through the center axis (rotary axis 38) of the blade holder 10 and intersects this axis.

FIG. 3 shows such a sample embodiment, in which the longitudinal axis 40 through the debarring blade 12 intersects the rotary axis 38 in the blade holder 10.

However the invention is not confined to this. In another embodiment it can also be provided that the longitudinal axis 40 of the debarring blade 12 is formed eccentrically to the rotary axis 38, that is, it does not intersect the rotary axis, but has an offset above or below the rotary axis 38.

Likewise, the invention is not confined to the arrangement of a single deburring blade 12 per FIG. 3. It can also be provided that an identical deburring blade 12 is aligned with the first deburring blade 12 in the longitudinal axis 40, diametrically opposite it or also pointing in the same direction (see FIG. 3c), but at a certain spacing.

Likewise, other deburring blades besides the deburring blade 12 can be provided, which are arranged not in the region of the longitudinal axis 40, but instead making an angle with the longitudinal axis 40 through the deburring blade 12, and likewise being arranged radially outwardly oriented on the outer circumference of the blade holder 10.

In one modification of the present invention, the invention moreover is not confined to having a single deburring blade on the blade holder, but instead several mutually parallel debarring blades 12 can also be provided at a certain angular position of the deburring blade, wherein the one deburring blade for example has a cutting edge for one direction, while the other deburring blade has a cutting edge 14 for another direction of the workpiece contour, this being represented in FIG. 3c.

What is important in all embodiments is that the deburring blade 12 in the spring-loaded base position is held in a neutral position already swiveled slanting out from the front base body 2 (see FIG. 3), and when performing a deburring operation along a radially nonround workpiece contour a feed motion now occurs at the tool shaft and the base body, by which the deburring blade is spring tensioned against the feed direction and under this spring loading it now travels along the workpiece contour (see FIG. 3a).

This results in a peeling or skiving effect, which thus reliably removes burr and chips clinging to the nonround workpiece contours.

FIG. 3 further shows that a detent pin 8 is arranged in the base body 2, which lies under tensioning against the front free end 6 of the bending spring 5. The front free end 6 engages under spring tensioning in the recess 7 of the blade holder 10.

The detent pin 8 thus lies against one side of the free springing end 6 of the bending spring 5, and thus tensions this in the neutral resting position, as is represented in FIG. 3, now already with a spring tensioning.

Thus, the longitudinal axis 40 of the blade holder 10 per FIG. 3 already comes under a spring tensioning, and the angle (resting angle 17) is formed between the vertical 21 and the longitudinal axis 40.

For the transition to the working position, the blade holder 10 together with the deburring blade 12 fastened there is swiveled further in the arrow direction 18 to the angle 19, so that the spring force of the bending spring 5 increases, and the swiveling in the arrow direction 18 occurs by overcoming the spring force of the bending spring 5.

Upon swiveling in the arrow direction 18, the working angle 19 is taken up, which shows a more outwardly swiveled position of the deburring blade 12. In the region of the working angle 19, an oscillating tracking takes place, that is, a spring-loaded tracking of the spring-tensioned deburring blade 12 in the arrow directions 20.

Thus, not only can radially nonround workpiece contours 24 be tracked per FIG. 2, but also those workpiece contours which have in addition to radial nonroundness also an axial offset from the plane of the drawing in FIG. 2.

Of course, deviations from the radial workpiece contour 24 are also taken into account, since the deburring blade 12 is moved spring-loaded against this workpiece contour 24, as represented in FIG. 2.

In FIG. 2 one notices that in a preferred embodiment the longitudinal axis 40 is normal to the longitudinal axis through the workpiece contour 24. That is, the deburring blade 12 is outwardly oriented in the perpendicular direction and is moved in this position along the workpiece contour 24 in the arrow direction 23.

The invention is not limited to a normal orientation of the longitudinal axis 40 of the deburring blade 12 relative to the workpiece contour 24. There can also be certain angle degrees in between, for example, angles in the range of 0 to 15 degrees, so that the longitudinal axis 40 then takes up an angle to the workpiece contour 24 and in this case a peeling or skiving action oriented at a slant to the longitudinal axis of the workpiece contour 24 will then occur.

As a whole, a workpiece is designated by the reference symbol 22, but it is only shown in FIG. 2 in the form of its workpiece contour 24.

FIG. 3a shows the swiveled out state of the deburring blade 12 when placed against a workpiece contour 24, while the traveling of the workpiece contour 24 occurs under the spring loading of the bending spring 5.

FIG. 3b shows a kinematic reversal of the deburring tool of FIG. 3 and FIG. 3a, which means that the deburring blade per FIG. 3b is suitable for deburring of radially interior nonround workpiece contours 24, while the deburring tool per FIGS. 3 and 3a is suitable for deburring of radially exterior workpiece contours.

FIG. 5 shows a deburring process of a radially exterior workpiece contour 24 on a workpiece 22. One can notice here that the bending spring 5 bends at its front free end and is tensioned against the detent pin 8, while a cutting edge 14 of the deburring blade 12 travels along the workpiece contour 24 perpendicular to the plane of the drawing in FIG. 5, namely, in the working direction 23.

FIG. 6 shows that such a deburring tool is suitable for the deburring of exterior workpiece contours in the interior of a workpiece. The deburring tool of FIG. 6 at first travels through the workpiece recess 26 and arrives in the radially exterior region of a hollow chamber 27, which is adjoined by a workpiece opening 36 axially below it.

The problem now is for the deburring blade 12 to deburr the radially exterior workpiece contour 24.

This is done by setting the cutting edge 14 against the workpiece contour 24 under the loading of the bending spring, which acts in the arrow direction 28,

On the whole, it can be said that the deburring blade 12 must have a certain rotary mobility in the lengthwise groove 3 of the base body 2, and for this purpose a clearance in the form of a lengthwise groove 15 is arranged there.

The lengthwise groove 15 serves to give the deburring blade 12 its angular mobility.

FIGS. 7 to 9 now show the process of introducing a deburring blade into a workpiece 22 according to FIG. 6. To guide the deburring tool, a path guiding machine 32 is used, in which the deburring tool is clamped. The path guiding machine 32 performs all guide movements in the arrow directions 29, 30 and 33. The guide movement in arrow direction 33 corresponds to the workpiece contour 24. Accordingly, the path guiding machine 32 feeds the deburring tool connected to it in the axial direction to a recess 26 in a workpiece 22.

According to FIG. 7, at first there is an (axially directed) downward movement in the arrow direction 29, by which the deburring tool plunges into the upper recess 26 of the workpiece 22.

After this, according to FIG. 8, the deburring blade is moved perpendicular to its longitudinal axis 39 in the radial arrow direction 30, and thus arrives with its outwardly slanting deburring blade behind the workpiece contour 24 being deburred.

Finally, FIG. 9 shows the base position shortly before commencing the deburring work. One can notice here that the deburring blade 12 lies in the resting position without spring loading against the workpiece contour 24, and that now a path following of the deburring tool also occurs in this base position according to the machine movement 33 of the path guiding machine 32. It is only represented by drawing that the machine movement 33 of the path guiding machine 32 dictates the guide path for the workpiece contour 24 being debarred, as was explained by means of FIG. 2.

Hence, the workpiece contour 24 being deburred must be entered prior to the deburring process of the workpiece contour 24 in the path guiding machine 32 in order for the control system of the path guiding machine 32 to dictate the workpiece contour 24 being followed, so that the at least one deburring blade 12 outfitted with at least one cutting edge 14 can be moved along the workpiece contour 24 under spring loading to remove chips along the workpiece contour 34.

FIG. 10 shows yet again the resting position according to FIG. 9 in magnified representation, while FIG. 11 shows the working position, showing that under the load of the bending spring 5 the deburring blade 12 is swiveled upward and is pressed under spring loading by its cutting edge 14 spring-loaded against the workpiece contour 24, where it removes chips.

It is important that the flank adjoining the workpiece contour 24 can have a certain flank tolerance 35, so that such flank tolerances 35 also have to be controlled by the spring loading of the deburring blade 12.

During the working, a feed motion 34 occurs in the direction of the longitudinal axis, and the deburring process then occurs in that the deburring blade 12 per FIG. 11 follows the nonround workpiece contour 24 of the workpiece 22 along a nonround path with a suitable path guiding machine, which executes the machine movement 33.

### LEGEND FOR DRAWINGS

1 Tool shaft
2 Base body
3 Lengthwise groove
4 Clamping strip
5 Bending spring
6 Free end of 5
7 Recess
8 Detent pin
9 Borehole for 8
10 Blade holder
11 Transverse fastening of 12
12 Deburring blade
13 Bearing bore
14 Cutting edge (of 12)
15 Lengthwise groove (in 2)
16 Clamp screw
17 Resting angle
18 Arrow direction
19 Working angle
20 Arrow direction
21 Vertical
22 Workpiece
23 Working direction
24 Workpiece contour
25 Guiding angle
26 Recess
27 Hollow chamber
28 Arrow direction (spring loading)
28 Arrow direction (feed)
29 Arrow direction
30 Longitudinal axis (recess 22)
31 Path guiding machine
33 Machine movement
34 Feed motion
35 Flank tolerance
36 Workpiece opening
37 End face
38 Rotary axis
39 Longitudinal axis (of 1, 2)
40 Longitudinal axis (of 12)

1. Deburring tool for deburring of nonround contours on workpieces (22) consisting of a tool shaft (1) for fastening in a path guiding machine 32, which is suitable to guiding the deburring tool (1, 2) by its machine movement (29, 30, 33) along a workpiece contour (24) which is nonround in at least the radial direction, wherein at least one deburring blade (12) having at least one cutting edge (14) is pressed under spring loading against the workpiece contour (34) in chip removing manner and can be moved along the workpiece contour (24).

2. Deburring tool according to claim 1, characterized in that the at least one cutting edge (14) of the deburring blade (12) machines with chip removal in the manner of a peeling or skiving tool the workpiece contour (24) which is nonround at least in the radial direction.

3. Deburring tool according to claim 1 or 2, characterized in that the longitudinal axis (40) of the deburring blade (12) is oriented roughly perpendicular to the workpiece contour (24).

4. Deburring tool according to one of claims 1 to 3, characterized in that the deburring blade (12) is accommodated by its longitudinal axis (40) in the radial direction on the circumference of a roughly cylindrical blade holder (10), which is accommodated rotatably and spring-loaded in a bearing bore (13) of a base body (2) of the deburring tool.

5. Deburring tool according to claim 4, characterized in that a radially outwardly opening recess (7) is arranged on the outer circumference of the rotatably mounted blade holder (10), in which the free bendable end (6) of a bending spring (5) engages, which is clamped at one side of the base body (2).

6. Deburring tool according to one of claims 1 to 5, characterized in that in the resting state the spring-loaded, swivel-mounted deburring blade (12) sticks out at a certain angle (17) beyond the outer contour of the base body (2).

7. Deburring tool according to one of claims 1 to 6, characterized in that two equiaxial deburring blades (12, 12) are arranged alongside each other at a mutual spacing in the blade holder (10), whose cutting edges (14) are set opposite each other.

8. Deburring tool according to one of claims 1 to 7, characterized in that the bearing bore (13) for the rotatable mounting of the blade holder (10) is configured eccentric to the center longitudinal axis (39) of the base body (2).

9. Deburring tool according to one of claims 1 to 7, characterized in that the bearing bore (13) for the rotatable mounting of the blade holder (10) is configured centrally and aligned in the longitudinal axis (39) of the deburring tool.

10. Deburring tool according to one of claims 1 to 9, characterized in that the fastening of the deburring blade (12) in the blade holder (10) is done in that the longitudinal axis (40) through the deburring blade (12) intersects the center axis (rotary axis 38) of the blade holder (10).
